(19) United States
(12) Patent Application Publication
(10) Pub. No.: US 2006/0122786 A1
(43) Pub. Date: Jun. 8, 2006

(54) Prediction model of cadaveric graft survival

(75) Inventor: Alex Goldfarb-Rumyantzev, Salt Lake City, UT (US)

Correspondence Address: TRASK BRITT, P.O. BOX 2550, SALT LAKE CITY, UT, 84110, US

(73) Assignee: University of Utah Research Foundation, Salt Lake City, UT (US)

(21) Appl. No.: 11/259,484

(22) Filed: Oct. 26, 2005

Related U.S. Application Data
(60) Provisional application No. 60/622,063, filed on Oct. 26, 2004.

(51) Int. Cl. G06F 19/00

(52) U.S. Cl. 702/19; 705/3

(57) ABSTRACT

Described are methods of predicting graft survival based on pre-transplant variables. A logistic regression (LM) and/or a tree-based model (TBM) are used to identify predictors of graft survival and to generate prediction algorithms. Both the logistic regression model and the tree-based model may be used in clinical practice for long term prediction or graft survival based on pre-transplant variables. The invention is also directed to computer software, which includes a logistic regression model and/or a tree-based model to select pre-transplant variables and generate a graft survival algorithm and to calculate a graft survival probability, and for selecting appropriate organ donors and recipients to optimize the graft survival probability.

### CROSS-REFERENCE TO RELATED APPLICATION

Pursuant to the provisions of 35 U.S.C. § 119(e), this application claims the benefit of the filing date of provisional patent application Ser. No. 60/622,063, filed Oct. 26, 2004, the contents of the entirety of which are incorporated herein by this reference.

### TECHNICAL FIELD

The invention relates to the field of models for predicting the overall probability of a tissue or organ graft surviving a certain period of time. More particularly, this invention is directed to a model using an algorithm to account for predictors available before an organ transplant to estimate the probability of kidney graft survival.

### BACKGROUND

Improved immunosupression has reduced acute rejection, but has had little effect on chronic allograft nephropathy and late graft loss (1). Causes of long-term allograft failure are recurrent disease and chronic allograft nephropathy. Pre and post-transplant predictive factors of graft survival for optimal and expanded criteria grafts have been extensively studied in adults (2, 3) and children (4-6). These studies were based on data from the United Network of Organ Sharing (UNOS) and North American Pediatric Renal Transplant Cooperative Study (NAPRTCS). Many of these studies focused on specific predictive factors such as donor age (7, 8), hypertension (HTN) and diabetes mellitus (DM) (9), non-heartbeating donor (10), cold storage time (11), body mass index (BMI) of donor and recipient (12), and high degree of donor vascular pathology (13) were associated with worse outcomes in multivariate analyses.

Other graft recipient factors important to graft survival include recipient's general health (14), race (15), underlying kidney disease (16) and previous treatment modalities. Additional high-risk factors that have been considered include re-transplant (17), multiple (>5) pre-transplant blood transfusions (18), human leukocyte antigen-B and DR (HLA) mismatch and advanced recipient age (19). Pre-transplant dialysis modality may impact patient outcome (20), while pre-emptive transplantation of kidneys from living donors is associated with longer allograft survival (21). The relationship between donor and recipient age, race, gender, and three-year graft survival has been previously reported (7, 30), and is non-linear. The effect of cold ischemia time was also previously reported (11). BMI of donor and recipient as well as recipient obesity in relation to outcome has been discussed in literature and found to have an important role in the prediction of the kidney allograft outcome in some studies (12, 33), while in others obese (high BMI) transplant recipients have similar outcomes to non-obese patients (34).

Attempts have been made to develop prediction models of graft survival (mostly short-term) (24) based on data available using different statistical models, such as Cox regression (25), and artificial neural networks (26). Similar data derived from univariate and multivariate analyses was used in a smaller study for cadaveric kidney allocation in a Northern Italy Transplant Program (36). The disclosure of each of the cited and included references in incorporated in its entirety herein.

It would be desirable to provide an accurate comprehensive model for predicting the probability of graft survival over a certain period of time. It would also be desirable to develop a graft survival model based on available pre-transplant variables that would be used to counsel potential graft recipients before the transplant procedure. Furthermore, it would be desirable to develop computer software that would include a graft survival model for use in a transplant program.

### SUMMARY OF THE INVENTION

Disclosed is a prediction algorithm used to predict graft survival based on pre-transplant variables only. Logistic regression models (LM) and tree-based models (TBM) may be used to select predictor variables and for the generation of prediction algorithms. Predictor variables may include age, gender, race, height, and weight for both donor and recipient, recipient cause of end-stage renal disease (ESRD), type of pre-transplant renal replacement therapy, number of previous kidney transplants and pre-transplant blood transfusions, recipients' most recent creatinine and donors' terminal creatinine, history and duration of diabetes and hypertension (HTN) in the donor, number of human leukocyte antigen (HLA) match and mismatch, cold ischemia time, kidney or kidney-pancreas transplant, and other suitable variables. The desired predictor variables and the prediction algorithms may be incorporated into a transplant program or a clinical practice for long-term prediction of kidney allograft survival for candidate donors and potential recipients. The prediction algorithms and the predictor variables may also be incorporated into a computer software program or medical record system enabling the health care practitioner to evaluate a patient's situation and advise the best course of action. Graft survival results may be used to counsel potential organ recipients even before putting them on the transplant list or whether or not to go ahead and accept an available organ for transplantation rather then remaining on dialysis and waiting for another organ.

### DESCRIPTION OF THE FIGURES

While the specification concludes with claims particularly pointing out and distinctly claiming that which is regarded as the present invention, the advantages of this invention and the best mode can be more readily ascertained from the following detailed description when read in conjunction with the accompanying drawings in which:

FIG. 1 shows the three-year graft survival and the donor and recipient age. Panel A is the three-year graft survival (%) and total number of kidney transplants vs. cadaver donor age. Panel B is the three-year graft survival (%) and total number of transplants vs. recipient age.

FIG. 2 shows graphs of the bivariate analysis of three-year graft survival (%) and relative body mass index (BMI), transplant center volume, and cold ischemia time. Panel A shows the relationship between donor-to-recipient BMI category and three-year graft survival with each dot representing a donor/recipient BMI category. Each of the 25 categories have the same number of patients (n=1496). Panel B represents the three-year graft survival and transplant center volume (total number of transplants with known outcomes over a study period) and Panel C shows the relationship of cold ischemia time and three-year graft survival.

FIG. 3 is a graph representing the odds ratios of the three-year graft survival for a selection of prediction variables.

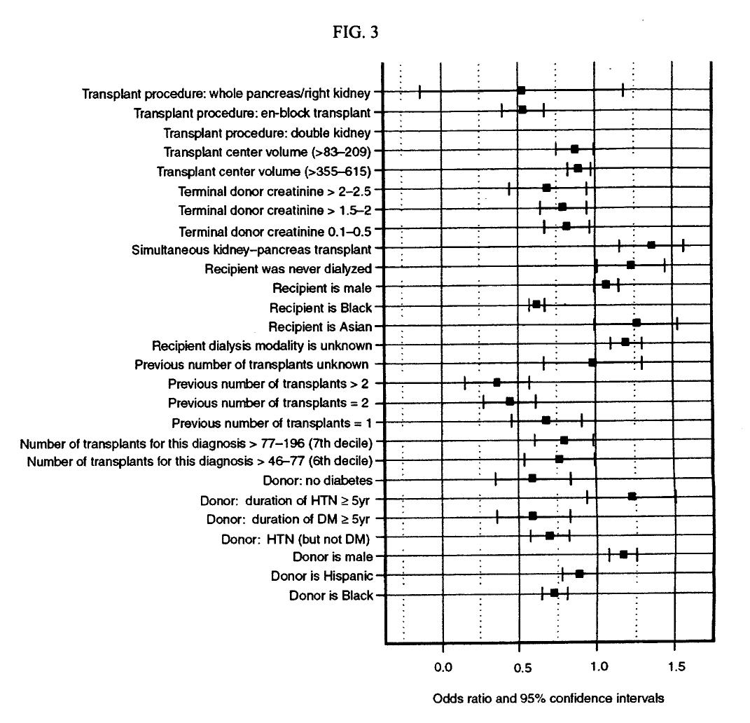

FIG. 4 shows the results of the prediction of three-year graft survival using logistic regression model on the testing dataset. All patients were divided in ten groups based on predicted probability of graft survival. The observed group averaged graft survival is compared with the predicted probability.

FIG. 5 shows the results of the prediction of three-year graft survival using a tree-based model on the testing dataset. All patients are divided in seven groups based on predicted probability of graft survival. The observed group averaged graft survival is compared with the predicted probability.

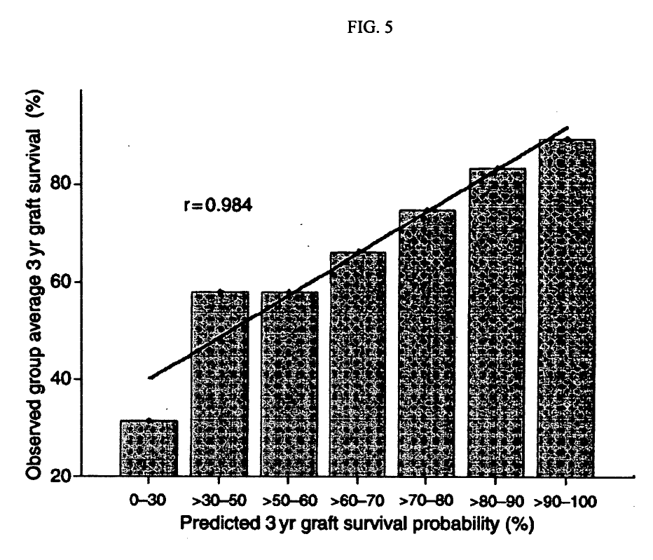

FIG. 6 is a diagram representing a tree-based model built using the training dataset. D—donor, R—recipient, Tx—transplant, CIT—cold ischemia time, “Y” and “N” at the terminal nodes of the tree correspond to predicted three-year graft survival (yes/no). The list of end-stage renal disease cause categories presented in the Appendix. *Transplant procedure group 1: left/right/en-bloc kidney with/without the whole pancreas with duodenum or whole pancreas with duodenal patch/left kidney. Transplant procedure group 2: double kidneys, pancreas segment with left kidney, whole pancreas with duodenum and double kidneys, whole pancreas with right kidney. Transplant procedure group 3: pancreas segment and left kidney, whole pancreas with duodenum and right/en-bloc kidney, whole pancreas and left kidney Transplant procedure group 4: left/right/en-bloc kidney, whole pancreas with duodenum and left kidney, whole pancreas with duodenal patch and left kidney, whole pancreas and right kidney.

### DETAILED DESCRIPTION OF THE INVENTION

It will be appreciated that the following detailed embodiments and examples described herein are illustrative only and do not limit the invention which is defined by the claims.

The present invention is a method of estimating the probability of organ and tissue graft survival using pre-transplant variables. The methods of the present invention use a logistic regression model (LM) and a tree-based model (TBM). Several features make TBM a powerful tool for building a prediction algorithm that can be successfully used in practice. TBM works when the regression variables are a mixture of categorical and continuous variables, it is often able to uncover complex interactions between predictors, which may be difficult or impossible to do using traditional multivariate techniques. The algorithm is non-parametric, so no assumptions are made regarding the underlying distribution of values of the predictor variables. TBM identifies splitting variables based on an exhaustive search of all possibilities, even in problems with many hundreds of possible predictors. Simultaneously, it requires relatively little input from the analyst. This graphical algorithm, presented as a collection of simple binary rules, is much simpler to interpret by a non-statistician than the multivariate LM. Thus can be used in the decision making without doing any additional calculations, and therefore is more likely to be followed in clinical practice.

### EXAMPLE 1

Patients were selected with end-stage renal disease (ESRD) that underwent kidney or kidney-pancreas transplantation and were listed on the US Scientific Registry of Transplant Recipients supplied by UNOS. The dataset includes transplants performed in infants and young children (minimal age, <1 year; maximum age 98 years). Independent variables (see Table 4) available for analysis included: age, gender, race, height, and weight for both donor and recipient, recipient cause of ESRD (Table 1), type of pre-transplant renal replacement therapy, number of previous kidney transplants and pre-transplant blood transfusions, recipients' most recent creatinine and donors' terminal creatinine, history and duration of diabetes and HTN in the donor, number of HLA match and mismatch, cold ischemia time, kidney or kidney-pancreas transplant, and transplant center code. One of skill in the art will recognize that the independent predictor variables are exemplary only and may be added to or modified as necessary or desired.

Statistical analysis. Bivariate analysis was performed using cross-tabulation and comparison of graft survival in the subgroup using the chi-square test. The Friedman supersmoothing method was used to fit the curve in bivariate analysis. Discrimination was determined by area under receiver operating characteristic (ROC) curve and chi-square for LM models. Model calibration was assessed using the Hosmer-Lemeshow goodness-of-fit test. For the purpose of prediction analysis, all records were randomly assigned either to a training set (n=25,000), used for knowledge acquisition and model development, or to a testing set (n=12,407), used to validate the models.

Predicted probabilities of three-year graft survival were generated on a testing set and compared with the actual patient outcomes. The predicted probability of the graft survival with group-average observed graft survival was used to compare the performance of the models. Also 2×2 contingency tables were used to determine positive and negative predictive values (PV).

Statistical methods used in the current invention include LM and classification trees. In certain situations, traditional statistical methods are poorly suited for complex interactions or detecting patterns in the data. Many possible predictor variables may violate the normality assumptions necessary for parametric analysis. In addition, the results of traditional methods sometimes may be difficult to use. Therefore, along with a traditional regression model that assumes linear relationship between predictors and the outcome, a TBM was used, which does not require the linearity assumption, and was used in clinical prediction before (28). TBM is an exploratory technique for uncovering structure in data, which generates a collection of many rules displayed in the form of binary tree (29).

TABLE 1
End-stage renal disease (ESRD) cause categories, based on
the total transplant number (n) for the specific diagnosis

| | |
|---|---|
| Category 1 | Radiation nephritis, lymphoma |
| (n = 1-5) | |
| Category 2 | Progressive systemic sclerosis, Wilms tumor, |
| (n = 6-12) | myeloma, antibiotic-induced nephritis, cancer |
| | chemotherapy induced nephritis, polyarteritis, |
| | urolithiasis |
| Category 3 | Nephrophthisis, gout, incidental carcinoma, |
| (n = 13-22) | cortical necrosis, heroin nephrotoxicity, |
| | renal artery thrombosis |
| Category 4 | Mesangio-capillary type 2 glomerulonephritis, |
| (n = 23-27) | cystinosis, Fabry's disease, sickle cell |
| | anemia, Goodpasture's syndrome, sarcoidosis |
| Category 5 | Oxalate nephropathy, amyloidosis, renal cell |
| (n = 28-46) | carcinoma, acute tubular necrosis, scleroderma |
| | nephrolithiasis |
| Category 6 | Familial nephropathy, Henoch-Schonlein purpura, |
| (n = 47-77) | prune belly syndrome, type 2 diabetes (insulin- |
| | dependent adult onset), membranous nephropathy, |
| | analgesic nephropathy, cyclosporin nephrotoxicity |
| Category 7 | Mesangio-capillary type 1 glomerulonephritis, |
| (n = 78-196) | anti-GBM disease, hemolytic uremic syndrome, |
| | medullary cystic disease, chronic |
| | glomerulosclerosis unspecified, Wegeners |
| | granulomatosis |
| Category 8 | Idiopathic/post-infectious crescentic |
| (n = 197-541) | glomerulonephritis, membranous |
| | glomerulonephritis, hypoplasia/dysplasia/ |
| | dysgensis/agenesis, acquired obstructive |
| | nephropathy, Alport's syndrome, chronic |
| | nephrosclerosis-unspecified, congenital |
| | obstructive uropathy |
| Category 9 | IgA nephropathy, chronic pyelonephritis/reffux |
| (n = 542-1176) | nephropathy, systemic lupus erythematosus, |
| | malignant HTN, retransplant/graft failure |
| Category 10 | Focal glomerularscherosis, polycystic kidneys, |
| (n = 1177-7777) | type 1 diabetes (insulin-dependent juvenile |
| | onset), type 2 diabetes (non-insulin-dependent |
| | adult onset), hypertensive nephrosclerosis, |
| | chronic glomerulonephritis unspecified, other |

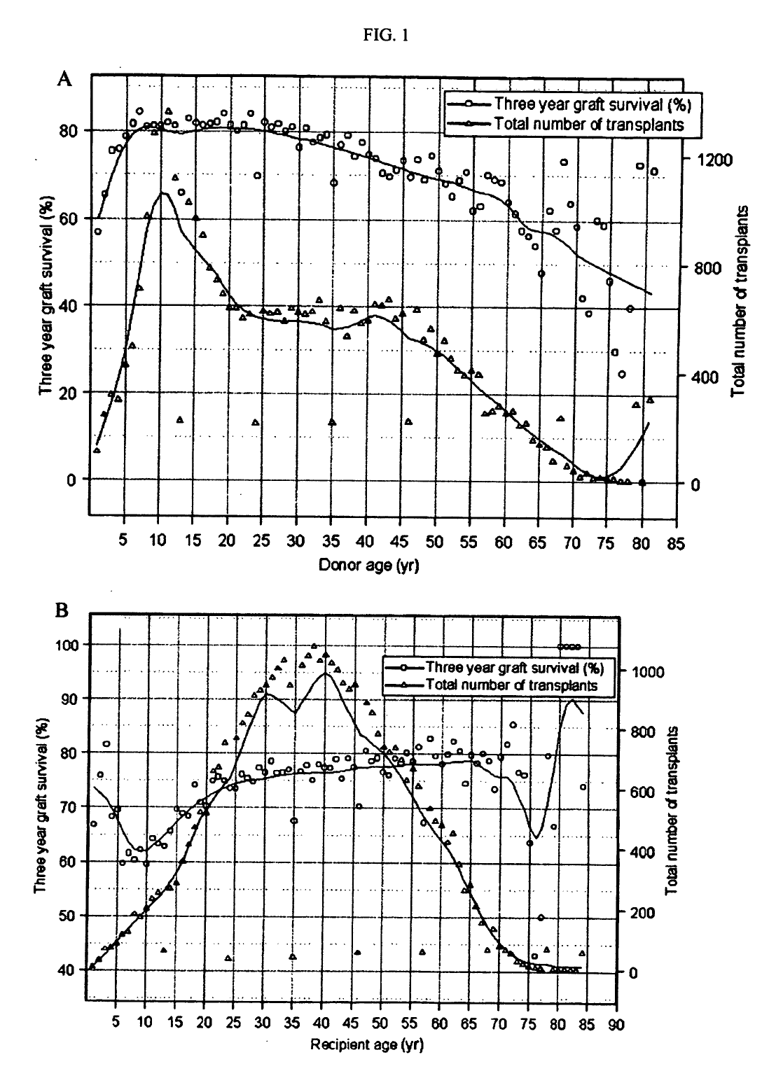

Bivariate analysis—donor and recipient characteristics. Donor and recipient characteristics. Young and old donors and recipients have lower three-year graft survival (p<0.001) (FIG. 1, panels A and B). There were differences in outcome associated with donor and recipient gender (Table 2) and race (Table 3) (p values presented in the tables). Kidneys from the donors with both diabetes mellitus (DM) and HTN had the worst three-year survival (59.3%), while those from the donors without either had the best outcome (76.3%). Kidneys from either diabetic or hypertensive donors were roughly in the middle (66.2 and 64.3%, respectively) (p<0.001). Increased duration of HTN and/or diabetes (from 1 to 5 years by one-year increments) in the donor was associated with worse outcome (p<0.001 for both). There is no relationship between donors terminal creatinine and graft survival. There were differences in outcome associated with different etiologies of renal failure (data not shown). Patients with no dialysis history (pre-emptive transplant) had the best three-year graft survival (81.3%, n=1,940) followed by those with history of peritoneal dialysis (76.1%, n=4,591) and then hemodialysis (73.0%, n=11,542) (p, 0.001). A previous transplant worsened three-year survival in almost a linear fashion with 76.7% survival in the recipient with no previous transplant history, 70.9, 62.1, and 56.9% in those with one, two and more than two previous transplants, respectively (p<0.001). Number of pre-transplant transfusions did not significantly affect graft survival in bivariate analysis.

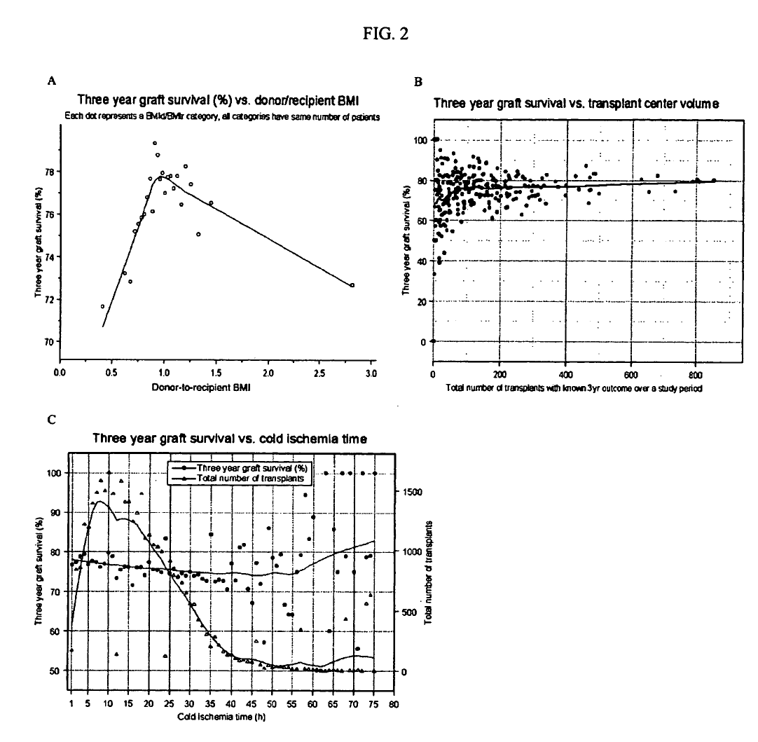

Transplant procedure, matching donor and recipient. The three-year survival improves and declines in linear fashion with increasing number of matched and mismatched antigens, respectively (p<0.001). Donor/recipient BMI vs. three-year graft survival looks almost like a bell-shape curve with the best outcome associated with the donor/recipient BMI=1 (FIG. 2, panel A). The worst survival was in grafts from relatively small donors to large recipients (p<0.001). Transplant centers with a low volume of transplants had variable outcome, while in those with high number of transplants the outcome was relatively uniform (FIG. 2, panel B). There was slight downward trend in relation of three-year graft survival to cold ischemia time (FIG. 2, panel C). Recipients of kidney-pancreas transplants had better three-year kidney survival (82.5%, n=3,243) than those receiving a single (75.7%, n=33,526) or en-bloc kidneys (68.2%, n=638) (p<0.001).

### EXAMPLE 2

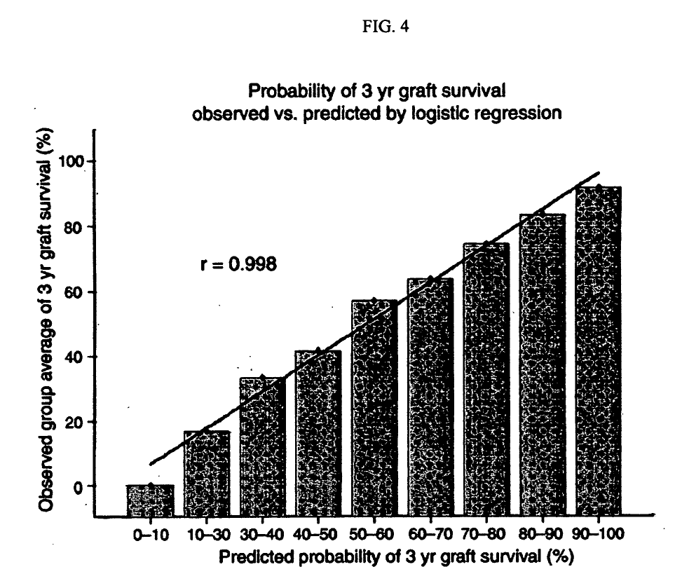

Multivariate analysis—logistic regression model (LM). Using stepwise forward selection, a significance level of 0.05 was set for independent variables to enter the model. The variables and model information are presented in Table 4. Odds ratios with 95% confidence intervals (CI) for the binary variables identified by the model are presented graphically (FIG. 4). Causes of ESRD (Table 1) in categories that demonstrated <70% three-year survival are: membranous nephropathy (66.2%), cyclosporin nephrotoxicity (68.3%), analgesic nephropathy (68.8%), type II insulin-dependent DM (65.6%), Henoch-Schonlein purpura (69.7%), mesangio-capillary type 1 glomerulonephritis (68.5%), hemolytic uremic syndrome (54.8%).

TABLE 2
Donor and recipient gender and three-year graft survival (%).

| | |
|---|---|
| Recipient | Donor |

| | Total | Percent | Total | Percent |
|---|---|---|---|---|
| Gender | number | survival | number | Survival |
| Female | 14,961 | 75.7 | 14,202 | 73.6 |
| Male | 22,446 | 76.7 | 23,205 | 77.9 |

TABLE 3
Donor and recipient race and three-year graft survival (%).

| | |
|---|---|
| Donor | Recipient |

| | Total | Percent | Total | Percent |
|---|---|---|---|---|
| Race | number | survival | number | Survival |
| White | 29,796 | 77.2 | 23,322 | 79.2 |
| Black | 3,968 | 69.7 | 8,852 | 67.0 |
| Hispanic | 2,943 | 75.4 | 3,493 | 78.2 |
| Asian | 432 | 73.6 | 1,194 | 81.0 |

Model discrimination using the c index (area under the receiver operating characteristic curve) was 0.653. This is the probability that for a randomly chosen pair of patients, the predicted and observed graft survival are concordant. Model calibration was assessed using the Hosmer-Lemeshow goodness-of-fit test. As the p value, p=0.63, of this test was not significant, the model's estimated probabilities of three-year graft survival are not significantly different from the actual survival of patients over groups spanning the entire range of probabilities.

### EXAMPLE 3

Prediction analysis—logistic regression (LM). To identify predictors of three-year graft survival and develop a prediction model using LM, 25,000 records were randomly selected as the training set, while the remaining 12,407 records were designated as a testing set and were used to compare predicted and observed three-year allograft survival. A LM model was again generated on the training set only. This model was 65% concordant, 34.5% discordant, and the c index was 0.653. Using the variables and parameter estimates generated with the training set, we calculated the probability of three-year graft survival in the testing set. All records were divided into ten groups based on deciles of predicted probability of graft survival (0-10%, >10-20%, >20-30%, etc.). The observed percentage of three-year graft survival was calculated for each group, and the observed graft survival was compared with the expected survival. As there was only one patient in the >10-20% group, that group was combined with the >20-30% group to produce a >10-30% group.

TABLE 4
Predictors of the outcome (three-year graft survival) identified by logistic regression.

| Independent variable | Coefficient | χ² | ρ | Odds ratio | 95% Cl |
|---|---|---|---|---|---|
| Intercept | 1.332 | 89.474 | <0.0001 | | |
| Donor age | −0.0145 | 297.87 | <0.0001 | | |
| Donor BMI | 0.0015 | 9.0748 | 0.0026 | | |
| Recipient BMI | −0.0121 | 42.774 | <0.0001 | | |
| Recipient age | 0.0146 | 231.46 | <0.0001 | | |
| HLA match | 0.1336 | 206.65 | <0.0001 | | |
| Cold ischemia time | −0.0079 | 35.701 | <0.0001 | | |
| Recipient is male | 0.0648 | 6.4246 | 0.0113 | 1.067 | 1.015-1.122 |
| Donor is male | 0.1467 | 30.611 | <0.0001 | 1.158 | 1.099-1.22 |
| Terminal donor creatinine 0.1-0.5 | −0.2087 | 10.343 | 0.0013 | 0.812 | 0.715-0.922 |
| Terminal donor creatinine >1.5-2 | −0.2389 | 12.579 | 0.0004 | 0.787 | 0.69-0.899 |
| Terminal donor creatinine >2-2.5 | −0.4012 | 8.8319 | 0.003 | 0.67 | 0.514-0.872 |
| Previous number of transplants = 1 | −0.4078 | 11.241 | 0.0008 | 0.665 | 0.524-0.844 |
| Previous number of transplants = 2 | −0.8534 | 35.723 | <0.0001 | 0.426 | 0.322-0.564 |
| Previous number of transplants >2 | −1.1078 | 25.17 | <0.0001 | 0.33 | 0.214-0.509 |
| Previous number of transplants unknown | −0.0454 | 0.1503 | 0.6982 | 0.956 | 0.76-1.202 |
| Donor is Black | −0.3229 | 66.57 | <0.0001 | 0.724 | 0.67-0.782 |
| Donor is Hispanic | −0.1247 | 7.1664 | 0.0074 | 0.883 | 0.806-0.967 |
| Recipient is Black | −0.4726 | 263.48 | <0.0001 | 0.623 | 0.589-0.66 |
| Recipient is Asian | 0.2201 | 8.065 | 0.0045 | 1.246 | 1.071-1.451 |
| Recipient was never dialyzed | 0.2001 | 9.7585 | 0.0018 | 1.222 | 1.077-1.385 |
| Recipient dialysis modality is unknown | 0.1754 | 33.774 | <0.0001 | 1.192 | 1.123-1.264 |
| Donor: HTN (but not DM) | −0.3701 | 32.775 | <0.0001 | 0.691 | 0.608-0.784 |
| Donor: no DM | −0.571 | 13.845 | 0.0002 | 0.565 | 0.418-0.763 |
| Donor: duration of DM ≧5 years | −0.5702 | 14.815 | 0.0001 | 0.565 | 0.423-0.756 |
| Donor: duration of HTN ≧5 years | 0.1856 | 4.7968 | 0.0285 | 1.204 | 1.02-1.421 |
| Simultaneous kidney-pancreas transplant | 0.3052 | 30.044 | <0.0001 | 1.357 | 1.217-1.513 |
| Transplant procedure: en-bloc transplant | −0.6445 | 47.954 | <0.0001 | 0.525 | 0.437-0.63 |
| Transplant procedure: double kidney | −12.727 | 0.021 | 0.8849 | <0.001 | >999.99 |
| Transplant procedure: whole pancreas/right kidney | −1.413 | 3.9032 | 0.0482 | 0.243 | 0.06-0.989 |
| Transplant center volume (>83-209) | −0.1436 | 8.2045 | 0.0042 | 0.866 | 0.785-0.956 |
| Transplant center volume (>355-615) | −0.1115 | 14.812 | 0.0001 | 0.895 | 0.845-0.947 |
| Number of transplants for this diagnosis >46-77 | −0.2942 | 7.2995 | 0.0069 | 0.745 | 0.602-0.922 |
| (6^{th} decile) | | | | | |
| Number of transplants for this diagnosis >77-196 | −0.2435 | 7.9364 | 0.0048 | 0.784 | 0.662-0.929 |
| (7^{th} decile) | | | | | |

BMI, body mass index
DM, diabetes mellitus
HTN, hypertension
HLA, human leukocyte antigen
CI, confidence interval

The midpoint of each group's probability range was used as the expected percent survival. As shown in FIG. 4 the prediction of the probability of graft survival from the training model achieved a very good match with the observed survival of the testing set, with a chi-square value of 6.15 and p=0.63, which shows no significant difference between observed and predicted category, and a correlation of r=0.998. The predicted allograft failure probability was converted into a binary variable (graft survival=“yes” or “no”) using a cut-point of 50% probability. The results were compared by means of a 2×2 contingency table. The positive PV of allograft survival with the model was 76% and the negative PV was 63%.

### EXAMPLE 4

Prediction analysis—tree-based model. A TBM was used to identify predictors of three-year graft survival and develop a prediction model. The outcome of cross-validation procedure in the form of deviance plotted against number of terminal nodes (tree size) was analyzed and the optimal size of the tree was determined to be equal to 54 terminal nodes. To identify predictors of the outcome, the initial tree was constructed on the whole dataset and pruned to 54 terminal nodes. The following 17 predictors of outcome (in order from the root of the tree to the terminal nodes) were identified by the TBM: recipient race, donor age, recipient weight, cold ischemia time, recipient height, previous number of transplants, recipient age, number of matched HLA antigens, donor race, cause of ESRD (Table 1), recipient gender, number of mismatched HLA antigens, recipient BMI, recipient weight, presence of diabetes and/or HTN, donor height, donor/recipient BMI. The residual mean deviance of the model is 1.03 and misclassification error rate was 0.23.

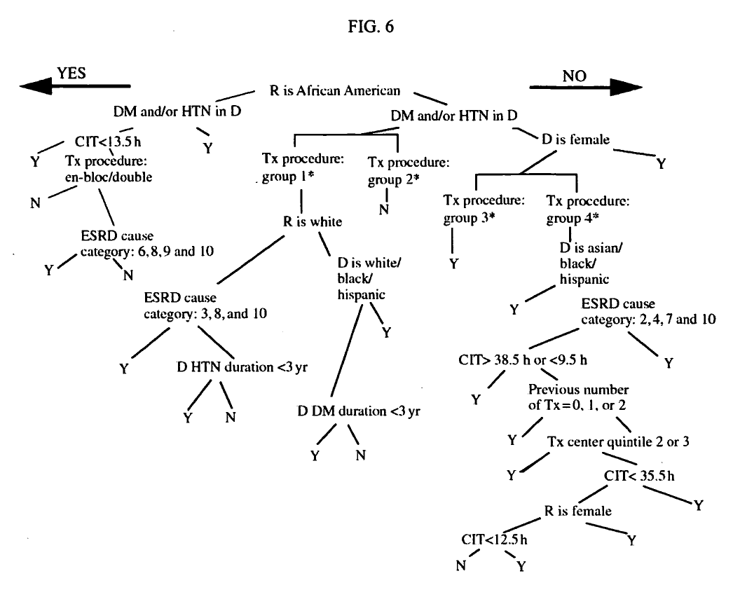

The new TBM was built upon a training set and validated on the testing set. Using the model generated with the training set, the probability of three-year graft survival was calculated in the testing set. All records were divided into ten groups based on deciles of predicted probability of graft survival (0-10%, >10-20%, >20-30%, etc.). The observed percentage of three-year graft survival was calculated for each group. The observed graft survival was compared with the expected survival. As there were only six patients in the 0-10% and >10-20% groups together, those groups were combined with the >20-30% group to produce a 0-30% group. For the same reason groups >30-40% and >40-50% were combined to produce >30-50% group. The midpoint of each group's probability range was used as the observed percent survival (FIG. 6).

The prediction of the probability of graft survival from the training model achieved a good correlation with the observed survival of the testing set (r=0.984). The predicted allograft failure probability was converted into a binary variable (graft survival=“yes” or “no”) using a cut-point of 50% probability (FIG. 6). The graph represents the model in a form of dichotomous tree, where each node presents a question regarding the value of a single independent variable. If the answer to the question is “yes” users move to the next node by way of the left branch (or right branch, if the answer is “no”) until it reaches the terminal node, which predicts three-year graft survival (Y or N). The results were compared by means of a 2×2 contingency table. The positive PV of the allograft survival with the model was 76.0% and the negative PV was 53.8%.

### REFERENCES

(the contents of all of which are incorporated by this reference in their entirety)
1. Halloran P. F., A. Melk and C. Barth. Rethinking chronic allograft nephropathy: the concept of accelerated cenescence. J. Am. Soc. Nephrol. 1999: 10:167.
2. Cecka J. M. The UNOS Scientific Renal Transplant Registry. In: J. M. Cecka and P. I. Terasaki, eds. Clinical Transplants. Los Angeles: UCLA Immunogenetics Center, 1999.
3. Gjertson D. W. Determinants of long-term survival of adult kidney transplants: a 1999 UNOS update. In: J. M. Cecka and P. I. Terasaki, eds. Clinical Transplants. Los Angeles: UCLA Immunogenetics Center, 1999.
4. Gjertson D. W. and J. M. Cecka. Determinants of long-term survival of pediatric kidney grafts reported to the United Network for Organ Sharing kidney transplant registry. Pediatr. Transplant 2001: 5:5.
5. Ishitani M., R. Isaacs, V. Norwood, S. Nock, and P. Lobo. Predictors of graft survival in pediatric living-related kidney transplant recipients. Transplantation 2000: 70:288.
6. Tejani A., D. M. Stablein, L. Donaldson, et al. Steady improvement in short-term graft survival of pediatric renal transplants: the NAPRTCS experience. In: J. M. Cecka and P. I. Terasaki, eds. Clinical Transplants. Los Angeles: UCLA Immunogenetics Center, 1999.
7. Terasaki P. I., D. W. Gjertson, J. M. Cecka, S. Takernoto, and Y. W. Cho. Significance of the donor age effect on kidney transplants. Clin. Transplant 1997: 11:366.
8. Alexander J. W., L. E. Bennett, and T. J. Breen. Effect of donor age on outcome of kidney transplantation. Transplantation 1994: 57:871.
9. Ojo A. O., A. B. Leichtman, J. D. Punch, et al. Impact of preexisting donor hypertension and diabetes mellitus on cadaveric renal transplant outcomes. Am. J. Kidney Dis. 2000: 36:153.
10. Sanchez-Fructuoso A. I., D. Prats, J. Torrente, et al. Renal transplantation from non-heart beating donors: a promising alternative to enlarge donor pool. J. Am. Soc. Nephrol. 2000: 11:350.
11. Jordan M. L., R. Shapiro, C. A. Vivas, et al. High-risk donors: expanding donor criteria. Transplant Proc. 1999: 31:1401.
12. Remuzzi G., J. Grinyo, P. Ruggenenti, et al. Early experience with dual kidney transplantation in adults using expanded donor criteria. J. Am. Soc. Nephrol. 1999: 10:2591.
13. Karpinski J., G. Lajoie, D. Cattran, et al. Outcome of kidney transplantation from high-risk donors is determined by both structure and function. Transplantation 1999: 67:1162.
14. Hariharan S. Long-term kidney transplant survival. Am. J. Kidney Dis. 2001: 38 (Suppl. 6):S44.
15. Young C. J. and R. S. Gaston. African Americans and renal transplantation: disproportionate need, limited access, and impaired outcomes. Am. J. Med. Sci. 2002: 323:94.
16. Bleyer A. J., L. A. Donaldson, M. McIntosh, and P. L. Adams. Relationship between underlying renal disease and renal transplantation outcome. Am. J. Kidney Dis. 2001: 37:1152.
17. Mouquet C., H. Benalia, E. Chartier-Kastler, et al. Renal retransplantation in adults. Comparative prognostic study. Progres en Urologie 1999: 9:239.
18. Chavers B. M., E. K. Sullivan, A. Tejani, and W. E. Harmon. Pretransplant blood transfusion and renal allograft outcome: a report of the North American Pediatric Renal Transplant Cooperative Study. Pediatr. Transplant 1997: 1:22.
19. Kim S. T., S. Lee, J. S. Kim, J. Ha, J. K. Chung, and S. J. Kim. Analysis of the factors affecting survival of renal transplant recipients. Transplant Proc. 1998: 30:3086.
20. VanBiesen, R. Vanholder, and N. Lameire. Impact of pretransplantation dialysis modality on patient outcome after renal transplantation: the role of peritoneal dialysis revisited. Perit. Dial. Int. 1999: 19:103.
21. Mange K. C., M. M. Joe, and H. Feldman. Effect of the use or nonuse of long-term dialysis on the subsequent survival of renal transplants from living donors. N. Engl. J. Med. 2001: 344:726.
22. Terasaki P. I. and J. M. Cecka. The center effect: is bigger better? In: J. M. Cecka and P. I. Terasaki, eds. Clinical Transplants. Los Angeles: UCLA Immunogenetics Center, 1999.
23. Lin H. M., H. M. Kauman, M. A. McBride, et al. Center-specific graft and patient survival rates: 1997 United Network for Organ Sharing (UNOS) report. JAMA 1998: 280:1153.
24. Nyberg S. L., A. J. Matas, M. Rogers, et al. Donor scoring system for cadaveric renal transplantation. Am. J. Transpl. 2001: 1:162.
25. Hennige M., C. O. Kohler, and G. Opelz. Multivariate prediction model of kidney transplant success rates. Transplantation 1986: 42:491.
26. Shoskes D. A., R. Ty, L. Barba, and M. Sender. Prediction of early graft function in renal transplantation using a computer
27. Landis J. R. and G. G. Koch. The measurement of observer agreement for categorical data. Biometrics 1977: 33:159.
28. Goldfarb-Rumyantzev A. S. and L. Pappas. Prediction of renal insuffciency in Pima Indians with nephropathy of type 2 diabetes mellitus. Am. J. Kidney Dis. 2002: 40:252.
29. Breiman L., J. H. Friedman, R. A. Olshen, and C. J. Stone. Classification and Regression Trees. Monterey, Calif.: Wadsworth and Brooks/Cole, 1984.
30. Degawa H., T. Nemoto, M. Uchiyama, et al. Effect of donor age on renal allograft survival. Transplant Proc. 1998: 30:3660.
31. Meier-Kriesche H. U., F. K. Port, A. O. Ojo, et al. Effect of waiting time on renal transplant outcome. Kidney Int. 2000: 58:1311.
32. Kasiske B. L., J. J. Snyder, A. J. Matas, M. D. Ellison, J. S. Gill, and A. T. Kausz. Preemptive kidney transplantation: the advantage and the advantaged. J. Am. Soc. Nephrol. 2002: 13:1358.
33. Meier-Kriesche H. U., M. Vaghela, R. Thambuganipalle, G. Friedman, M. Jacobs, and B. Kaplan. The effect of body mass index on long-term renal allograft survival. Transplantation 1999: 68:1294.
34. Howard R. J., V. B. Thai, P. R. Patton, et al. Obesity does not portend a bad outcome for kidney transplant recipients. Transplantation 2002: 73:53.
35. Healey P. J., R. McDonald, J. H. Waldhausen, R. Sawin, and D. Tapper. Transplantation of adult living donor kidneys into infants and small children. Arch. Surg. 2000: 135:1035.
36. Poli F., M. Scalamogna, M. Cardillo, E. Porta, and G. Sirchia. An algorithm for cadaver kidney allocation based on a multivariate analysis of factors impacting on cadaver kidney graft survival and function. Transpl. Int. 2000: 13 (Suppl. 1):S259.

What is claimed is:

1. A method of predicting a probability of graft survival, said method comprising:
selecting pre-transplant variables using a logistic regression model;
generating a graft survival algorithm using a logistic regression model; and
calculating the probability of graft survival using the pre-transplant variables and the graft survival algorithm.

2. The method according to claim 1, wherein the pre-transplant variables are selected from the group consisting of age, gender, race, height, and weight for both donor and recipient, recipient cause of end-stage renal disease, type of pre-transplant renal replacement therapy, number of previous kidney transplants and pre-transplant blood transfusions, recipients' most recent creatinine and donors' terminal creatinine, history and duration of diabetes and hypertension in the donor, number of human leukocyte antigen (HLA) match and mismatch, cold ischemia time, kidney or kidney-pancreas transplant, transplant center, and combinations thereof.

3. The method according to claim 1, further comprising:
developing a computer software program comprising a logistic regression model for selecting the pre-transplant variables and for generating the graft survival algorithm;
calculating the probability of graft survival by using the computer software program;
storing donor and recipient pre-transplant variables using the computer software program; and
selecting appropriate organ donors and recipients in order to optimize the probability of graft survival.

4. A method of predicting a probability of graft survival, said method comprising:
selecting pre-transplant variables using a tree-based model;
generating a graft survival algorithm using a tree-based model; and
calculating the probability of graft survival using the pre-transplant variables and the graft survival algorithm.

5. The method according to claim 4, wherein the pre-transplant variables are selected from the group consisting of age, gender, race, height, and weight for both donor and recipient, recipient cause of end-stage renal disease, type of pre-transplant renal replacement therapy, number of previous kidney transplants and pre-transplant blood transfusions, recipients' most recent creatinine and donors' terminal creatinine, history and duration of diabetes and hypertension in the donor, number of human leukocyte antigen (HLA) match and mismatch, cold ischemia time, kidney or kidney-pancreas transplant, transplant center, and combinations thereof.

6. The method according to claim 4, further comprising:
developing a computer software program comprising a tree-based model for selecting the pre-transplant variables and for generating the graft survival algorithm;
calculating the probability of graft survival by using the computer software program;
storing donor and recipient pre-transplant variables using the computer software; and
selecting appropriate organ donors and recipients in order to optimize the probability of graft survival.

7. A method of predicting a probability of graft survival, said method comprising:
selecting pre-transplant variables using a logistic regression model and a tree-based model;
generating a graft survival algorithm using a logistic regression model and a tree-based model; and
calculating the probability of graft survival using the pre-transplant variables and the graft survival algorithm.

8. The method according to claim 7, wherein the pre-transplant variables are selected from the group consisting of age, gender, race, height, and weight for both donor and recipient, recipient cause of end-stage renal disease, type of pre-transplant renal replacement therapy, number of previous kidney transplants and pre-transplant blood transfusions, recipients' most recent creatinine and donors' terminal creatinine, history and duration of diabetes and hypertension in the donor, number of human leukocyte antigen (HLA) match and mismatch, cold ischemia time, kidney or kidney-pancreas transplant, transplant center, and combinations thereof.

9. The method according to claim 7, further comprising:
developing a computer software program comprising a logistic regression model and a tree-based model for selecting the pre-transplant variables and for generating the graft survival algorithm;
calculating the probability of graft survival by using the computer software program;
storing donor and recipient pre-transplant variables using the computer software program; and
selecting appropriate organ donors and recipients in order to optimize the probability of graft survival.

10. The method according to claim 3, wherein the probability of graft survival is calculated for a certain period of time.

11. The method according to claim 3, wherein the probability of graft survival is used to decide if a potential graft recipient should be transplanted or not.

12. The method according to claim 6, wherein the probability of graft survival is calculated for a certain period of time.

13. The method according to claim 6, wherein the probability of graft survival is used to decide if a potential graft recipient should be transplanted or not.

14. The method according to claim 9, wherein the probability of graft survival is calculated for a certain period of time.

15. The method according to claim 9, wherein the probability of graft survival is used to decide if a potential graft recipient should be transplanted or not.
